(19) United States
(12) Patent Application Publication
(10) Pub. No.: US 2026/0318223 A1
(43) Pub. Date: Oct. 15, 2026

(54) BEARING DAMPER ASSEMBLY FOR A TURBINE ENGINE

(71) Applicant: General Electric Company, Evendale, OH (US)

(72) Inventors: Ravindra Shankar Ganiger, Bengaluru (IN); Bugra H. Ertas, Niskayuna, NY (US)

(21) Appl. No.: 19/174,167

(22) Filed: Apr. 9, 2025

(51) Int. Cl. F01D 25/16; F16C 35/04

(52) U.S. Cl. CPC F01D 25/164; F16C 35/04; F05D 2240/50; F05D 2260/38; F05D 2260/96

(57) ABSTRACT

A bearing damper assembly for a turbine engine includes a damper frame and a bearing housing disposed in the damper frame. The bearing housing includes a housing base, an outer rim coupled to the housing base via a first plurality of integral springs such that a first plurality of annular gaps is formed between the outer rim and the housing base, and an inner rim coupled to the housing base via a second plurality of integral springs such that a second plurality of annular gaps is formed between the inner rim and the housing base. The first plurality of annular gaps and the second plurality of annular gaps are configured to be filled with fluid via a first fluid circuit and a second fluid circuit, respectively, of the bearing damper assembly to damp vibrations produced on a rotating component of the turbine engine.

### TECHNICAL FIELD

The present disclosure generally relates to bearing damper assemblies for turbine engines.

### BACKGROUND

Turbine engines, for example, for an aircraft, generally include a fan section and a turbo-engine to drive the fan section. Turbo-engines generally include a compressor section, a combustion section, and a turbine section in a serial flow arrangement. One or more bearing damper assemblies may reduce vibration of a rotating component of the turbo-engine.

### BRIEF DESCRIPTION OF THE DRAWINGS

Features and advantages of the present disclosure will be apparent from the following description of various exemplary embodiments, as illustrated in the accompanying drawings, wherein like reference numbers generally indicate identical, functionally similar, and/or structurally similar elements.

FIG. 1 is a schematic, cross-sectional diagram of a turbine engine, taken along a longitudinal centerline axis of the turbine engine, according to an embodiment of the present disclosure.

FIG. 2 is a schematic view of an exemplary bearing damper assembly of a turbine engine, such as the turbine engine of FIG. 1, according to an embodiment of the present disclosure.

FIG. 3 is a schematic, cross-sectional view of a bearing damper assembly of a turbine engine, such as the turbine engine of FIG. 1, according to another embodiment of the present disclosure.

FIG. 4 is an enlarged, cross-sectional, detail view of the area labeled “4” in FIG. 3.

FIG. 5 is a front, elevational view of a bearing housing of the bearing damper assembly of FIGS. 3 and 4.

FIG. 6 is an enlarged, detail view of the area labeled “6” in FIG. 5.

FIG. 7 is an enlarged, detail view of the area labeled “7” in FIG. 5.

FIG. 8 is a schematic, cross-sectional view of a first fluid circuit and a second fluid circuit of the bearing damper assembly of FIGS. 3-7, according to the present disclosure.

FIG. 9 is a schematic, cross-sectional view of a bearing damper assembly of a turbine engine, such as the turbine engine of FIG. 1, according to another embodiment of the present disclosure.

FIG. 10 is an enlarged, cross-sectional, detail view of the area labeled “10” in FIG. 9.

FIG. 11 is a flowchart showing a method of damping vibrations of a rotating component of a turbine engine via a bearing damper assembly, such as the bearing damper assembly of FIGS. 3-8, according to an embodiment of the present disclosure.

### DETAILED DESCRIPTION

Features, advantages, and embodiments of the present disclosure are set forth or apparent from a consideration of the following detailed description, drawings, and claims. Moreover, the following detailed description is exemplary and intended to provide further explanation without limiting the scope of the disclosure as claimed.

Various embodiments of the present disclosure are discussed in detail below. While specific embodiments are discussed, this is done for illustration purposes only. A person skilled in the relevant art will recognize that other components and configurations may be used without departing from the present disclosure.

As used herein, the terms “first,” “second,” “third,” etc., may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “forward” and “aft” refer to relative positions within a turbine engine or vehicle, and are based on a normal operational attitude of the turbine engine or vehicle. More particularly, forward and aft are used herein with reference to a direction of travel of the vehicle. More particularly, forward and aft are used herein with reference to a direction of travel of the vehicle and a direction of propulsive thrust of the turbine engine.

The terms “coupled,” “fixed,” “attached,” “connected,” and the like, refer to both direct coupling, fixing, attaching, or connecting, as well as indirect coupling, fixing, attaching, or connecting through one or more intermediate components or features, unless otherwise specified herein.

The singular forms “a,” “an,” and “the” include plural references unless the context clearly dictates otherwise.

As used herein, the terms “axial” and “axially” refer to directions and orientations that extend substantially parallel to a longitudinal centerline axis of the turbine engine. Moreover, the terms “radial” and “radially” refer to directions and orientations that extend substantially perpendicular to the longitudinal centerline axis of the turbine engine. In addition, as used herein, the terms “circumferential” and “circumferentially” refer to directions and orientations that extend arcuately about the longitudinal centerline axis of the turbine engine.

As used herein, the term “rotating component” refers to any component of a rotary machine, such as a turbine engine, that rotates about an axis of rotation. By way of example, a rotating component may include a shaft or a spool of a turbine engine, such as a fan shaft, a high-pressure shaft, a low-pressure shaft, etc. Likewise, the term “static component,” as used herein, refers to any stationary or non-rotating component of a turbine engine that has a coaxial configuration and an arrangement with a rotating component of the turbine engine. A static component may be disposed radially inward or radially outward along a radial axis in relation to at least a portion of a rotating component. Additionally, or alternatively, a static component may be disposed axially adjacent to at least a portion of a rotating component.

As used herein, the term “static structure” refers to any structural part of a rotary machine, such as a turbine engine, that is non-rotating.

As used herein, “redline speed” means the maximum expected rotational speed of a shaft or a rotor during normal operation of a turbine engine. The redline speed may be expressed in terms of rotations per second in Hertz (Hz), rotations per minute (RPM), or as a linear velocity of the outer diameter of the shaft in terms of feet per second. For a turbine engine that has a high speed shaft and a low speed shaft, both the high speed shaft and the low speed shaft have redline speeds.

As used herein, “critical speed” means a rotational speed of a shaft or a rotor of a turbine engine that is about the same as a fundamental, or a natural frequency, of a first-order bending mode of the shaft (e.g., the shaft rotates at eighty Hz and the first-order modal frequency is eighty Hz). When the shaft rotates at the critical speed, the shaft is expected to have a maximum amount of deflection, hence, instability, due to excitation of the first-order bending mode of the shaft. The critical speed may be expressed in terms of rotations per second in Hz, RPM, or as a linear velocity of the outer diameter of the shaft in terms of feet per second.

The term “supercritical speed,” as used herein, refers to a rotational speed of a shaft or a rotor of a turbine engine that is above a fundamental, or a natural frequency of a first-order bending mode of the shaft (e.g., the shaft rotates at eighty Hz while the first-order modal frequency is about seventy Hz). A “supercritical shaft” is a shaft that has a redline speed above the critical speed of the shaft.

As used herein, the terms “additively manufactured” or “additive manufacturing techniques or processes” generally refer to manufacturing processes wherein successive layers of material(s) are provided on each other to “build-up,” layer-by-layer, a three-dimensional component. The successive layers generally fuse together to form a monolithic component that may have a variety of integral sub-components. Although additive manufacturing technology is described herein as enabling fabrication of complex objects by building objects point-by-point, layer-by-layer, typically, in a vertical direction, other methods of fabrication are possible and within the scope of the present subject matter. For example, although the discussion herein refers to the addition of material to form successive layers, one skilled in the art will appreciate that the methods and the structures disclosed herein may be practiced with any additive manufacturing technique or manufacturing technology. For example, embodiments of the present disclosure may use layer-additive processes, layer-subtractive processes, or hybrid processes.

Approximating language, as used herein throughout the specification and claims, is applied to modify any quantitative representation that could permissibly vary without resulting in a change in the basic function to which it is related. Accordingly, a value modified by a term or terms, such as “about” and “substantially” is not to be limited to the precise value specified. In at least some instances, the approximating language may correspond to the precision of an instrument for measuring the value, or the precision of the methods, or the machines for constructing the components, and/or the systems or manufacturing the components and/or the systems. For example, the approximating language may refer to being within a one, two, four, ten, fifteen, or twenty percent margin in either individual values, range(s) of values and/or endpoints defining range(s) of values.

Here and throughout the specification and claims, range limitations are combined, and interchanged. Such ranges are identified and include all the sub-ranges contained therein unless context or language indicates otherwise. For example, all ranges disclosed herein are inclusive of the endpoints, and the endpoints are independently combinable with each other.

Generally, a turbine engine (e.g., a turbofan engine) may facilitate transfer of energy between a fluid and a rotating component (e.g., a rotor). For example, a compressor of a turbofan engine may utilize the rotating component to transfer energy to the fluid by compressing the fluid. Further, a turbine engine may also use the rotating component to extract energy from a flow of the fluid. To facilitate the transfer of energy, a tangential force may actuate (e.g., rotate) the rotating component. However, the rotating component may exert an axial force and a radial force on the rest of the turbine engine. For example, rotation of the rotating component may cause mass imbalance and, thus, vibrations (e.g., radial forces) in the turbine engine. Additionally, the rotating component may exert a radial (e.g., downward) force due to gravity. Furthermore, when the turbine engine is in operation, the rotating component may exert an axial (e.g., a thrust) force.

To help account for these various forces exerted by the rotating component, turbine engines commonly include one or more bearing damper assemblies engaged with one or more rotating components of the turbine engine. For example, a bearing damper assembly may dissipate vibrations (e.g., dynamic radial forces) produced on the rotating component, thereby reducing the vibrations transferred to the rest of the turbine engine. Additionally, a bearing damper assembly may support the rotating component against other radial forces and axial forces to facilitate actuation of the rotating component. However, in some instances, tuning a bearing damper assembly to account for the other radial forces and axial forces may affect the ability of the bearing damper assembly to dissipate vibrations.

One solution, for example, is a bearing damper assembly that includes a damper (i.e., a bearing housing) having multiple annular gaps (e.g., a segmented squeeze film damper) and bearings coupled between the damper and the rotating component. As such, a force exerted on the rotating component may be transferred to the damper through the bearings. For example, vibrations produced on the rotating component may propagate from the rotating component, through the bearings, and into the damper, where such vibrations may be dissipated by fluid in the annular gaps thereof. The damping characteristics of the damper may be based at least in part on pressure of fluid in the annular gaps and a size of the annular gaps. For example, adjusting fluid pressure and annular gap size may affect vibration frequencies dampened (e.g., dissipated) by the damper. As such, the fluid pressure and annular gap size may be tuned (e.g., adjusted) to target the natural frequency of the turbine engine, which may facilitate reducing an effect the vibrations have on the rest of the turbine engine.

However, as described above, the rotating component may exert other radial forces and axial forces on the bearing damper assembly. When insufficiently offset, such axial forces and radial forces may dynamically change the fluid pressure and annular gap size of the damper and, thus, targeted vibration frequencies. For example, axial (thrust) forces may cause axial movement in the damper, which may disrupt flow of fluid through an axial gap and, thus, fluid pressure in the annular gap. Additionally, a radial (e.g., gravitational) force may cause radial movement in the damper, which may reduce a size of one annular gap while increasing a size of another annular gap. Accordingly, to maintain targeted damping characteristics (e.g., dampened vibration frequencies and damping capabilities), the bearing assembly may offset the axial forces and the radial forces to facilitate maintaining annular gap size and fluid pressure in the annular gaps.

Moreover, some turbine engines may require some rotating components thereof (e.g., a low-pressure shaft or a high-pressure shaft) to have the ability to operate at supercritical speeds. Operation at supercritical speeds brings several challenges in rotor dynamics, including high speed stability and synchronous response to rotor imbalance. Furthermore, supercritical rotors require traversing through several rotor modes before achieving red line operating speeds. Thus, there is an optimum damping requirement for each mode and operating speed. For example, overly large damping force coefficients can lead to lowered stability margins and high dynamics bearing loads, and sufficiently low damping values can have the same effect. In other words, each operating mode requires optimum damping characteristics that may vary relative to other operating modes. However, as discussed above, traditional squeeze film dampers of bearing damper assemblies are typically designed (e.g., having particular integral spring stiffness, annular gap size, etc.) for a single target damping characteristic and do not have the capability to vary damping characteristics as needed.

Accordingly, the present disclosure provides for an improved bearing damper assembly for a turbine engine that can be operated in a plurality of variable damping modes for various operating modes of the turbine engine. Particularly, embodiments of the present disclosure can provide a bearing damper assembly with a first plurality of annular gaps and a second plurality of annular gaps, radially inward of the first plurality of annular gaps, that can be activated independent of one another to provide various damping characteristics of the bearing damper assembly, which can increase operational performance and durability of the bearing damper assembly and the turbine engine over a range of operating modes.

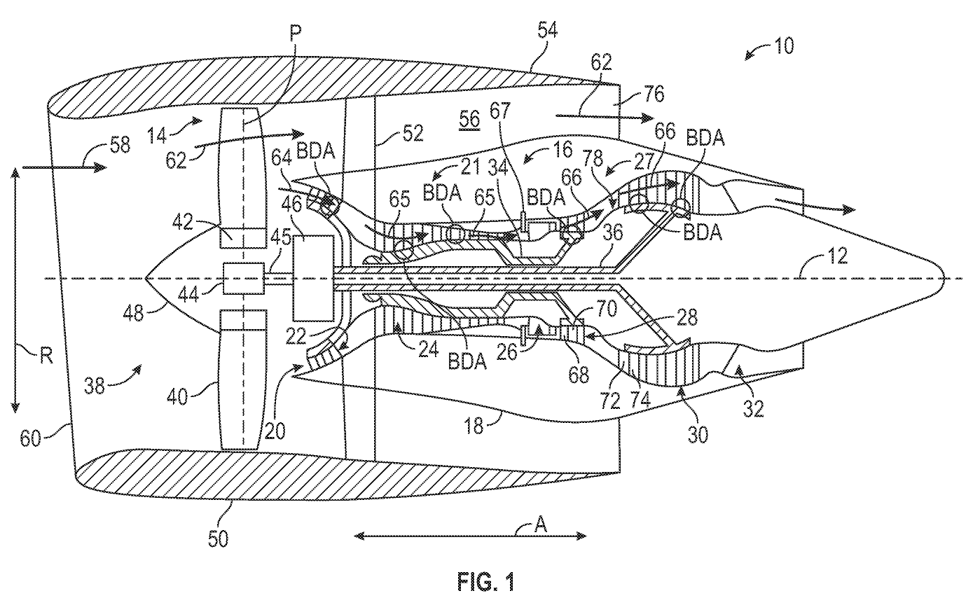

Referring now to the drawings, FIG. 1 is a schematic, cross-sectional diagram of a turbine engine 10, taken along a longitudinal centerline axis 12 of the turbine engine 10, according to an embodiment of the present disclosure. As shown in FIG. 1, the turbine engine 10 defines an axial direction A (extending parallel to the longitudinal centerline axis 12 provided for reference) and a radial direction R that is normal to the axial direction A. In general, the turbine engine 10 includes a fan section 14 and a turbo-engine 16 disposed downstream from the fan section 14.

The turbo-engine 16 includes, in serial flow relationship, a compressor section 21, a combustion section 26, and a turbine section 27. The turbo-engine 16 is substantially enclosed within an outer casing 18 that is substantially tubular and defines a core inlet 20 that is annular about the longitudinal centerline axis 12. As schematically shown in FIG. 1, the compressor section 21 includes a booster or a low-pressure (LP) compressor 22 followed downstream by a high-pressure (HP) compressor 24. The combustion section 26 is downstream of the compressor section 21. The turbine section 27 is downstream of the combustion section 26 and includes a high-pressure (HP) turbine 28 followed downstream by a low-pressure (LP) turbine 30. The turbo-engine 16 further includes a jet exhaust nozzle section 32 that is downstream of the turbine section 27, a high-pressure (HP) shaft 34 or a spool, and a low-pressure (LP) shaft 36. The HP shaft 34 drivingly connects the HP turbine 28 to the HP compressor 24. The HP turbine 28 and the HP compressor 24 rotate in unison through the HP shaft 34. The LP shaft 36 drivingly connects the LP turbine 30 to the LP compressor 22. The LP turbine 30 and the LP compressor 22 rotate in unison through the LP shaft 36. The compressor section 21, the combustion section 26, the turbine section 27, and the jet exhaust nozzle section 32 together define a core air flow path.

For the embodiment depicted in FIG. 1, the fan section 14 includes a fan 38 (e.g., a variable pitch fan) having a plurality of fan blades 40 coupled to a disk 42 in a spaced apart manner. As depicted in FIG. 1, the fan blades 40 extend outwardly from the disk 42 generally along the radial direction R. In the case of a variable pitch fan, the plurality of fan blades 40 is rotatable relative to the disk 42 about a pitch axis P by virtue of the fan blades 40 being operatively coupled to an actuation member 44 configured to collectively vary the pitch of the fan blades 40 in unison. The fan blades 40, the disk 42, and the actuation member 44 are together rotatable about the longitudinal centerline axis 12 via a fan shaft 45 that is powered by the LP shaft 36 across a power gearbox, also referred to as a gearbox assembly 46. In this way, the fan 38 is drivingly coupled to, and powered by, the turbo-engine 16, and the turbine engine 10 is an indirect drive engine. The gearbox assembly 46 is shown schematically in FIG. 1. The gearbox assembly 46 is a reduction gearbox assembly for adjusting the rotational speed of the fan shaft 45 and, thus, the fan 38 relative to the LP shaft 36 when power is transferred from the LP shaft 36 to the fan shaft 45.

Referring still to the exemplary embodiment of FIG. 1, the disk 42 is covered by a fan hub 48 that is aerodynamically contoured to promote an airflow through the plurality of the fan blades 40. In addition, the fan section 14 includes an annular fan casing or a nacelle 50 that circumferentially surrounds the fan 38 and at least a portion of the turbo-engine 16. The nacelle 50 is supported relative to the turbo-engine 16 by a plurality of outlet guide vanes 52 that are circumferentially spaced about the nacelle 50 and the turbo-engine 16. Moreover, a downstream section 54 of the nacelle 50 extends over an outer portion of the turbo-engine 16, and, with the outer casing 18, defines a bypass airflow passage 56 therebetween.

During operation of the turbine engine 10, a volume of air 58 enters the turbine engine 10 through an inlet 60 of the nacelle 50 or the fan section 14. As the volume of air 58 passes across the fan blades 40, a first portion of air, also referred to as bypass air 62, is routed into the bypass airflow passage 56, and a second portion of air, also referred to as core air 64, is routed into the upstream section of the core air flow path through the core inlet 20 of the LP compressor 22. The ratio between the bypass air 62 and the core air 64 is commonly known as a bypass ratio. The pressure of the core air 64 is then increased, generating compressed air 65. The compressed air 65 is routed through the HP compressor 24 and into the combustion section 26, where the compressed air 65 is mixed with fuel 67 and ignited to generate combustion gases 66.

The combustion gases 66 are routed into the HP turbine 28 and expanded through the HP turbine 28 where a portion of thermal energy or kinetic energy from the combustion gases 66 is extracted via one or more stages of HP turbine stator vanes 68 and HP turbine rotor blades 70 that are coupled to the HP shaft 34. This causes the HP shaft 34 to rotate, thereby supporting operation of the HP compressor 24 (e.g., a self-sustaining cycle). In this way, the combustion gases 66 do work on the HP turbine 28. The combustion gases 66 are then routed into the LP turbine 30 and expanded through the LP turbine 30. Here, a second portion of the thermal energy or the kinetic energy is extracted from the combustion gases 66 via one or more stages of LP turbine stator vanes 72 and LP turbine rotor blades 74 that are coupled to the LP shaft 36. This causes the LP shaft 36 to rotate, thereby supporting operation of the LP compressor 22 (e.g., a self-sustaining cycle) and rotation of the fan 38 via the gearbox assembly 46. In this way, the combustion gases 66 do work on the LP turbine 30.

The combustion gases 66 are subsequently routed through the jet exhaust nozzle section 32 of the turbo-engine 16 to provide propulsive thrust. Simultaneously, the bypass air 62 is routed through the bypass airflow passage 56 before being exhausted from a fan nozzle exhaust section 76 of the turbine engine 10, also providing propulsive thrust. The HP turbine 28, the LP turbine 30, and the jet exhaust nozzle section 32 at least partially define a hot gas path 78 for routing the combustion gases 66 through the turbo-engine 16.

The turbine engine 10 depicted in FIG. 1 is by way of example only. In other exemplary embodiments, the turbine engine 10 may have any other suitable configuration. For example, in other exemplary embodiments, the fan 38 may be configured in any other suitable manner (e.g., as a fixed pitch fan) and further may be supported using any other suitable fan frame configuration. The turbine engine 10 may also be a direct drive engine, which does not have a power gearbox. The fan speed is the same as the LP shaft speed for a direct drive engine. Moreover, in other exemplary embodiments, any other suitable number or configuration of compressors, turbines, shafts, or a combination thereof may be provided. In still other exemplary embodiments, aspects of the present disclosure may be incorporated into any other suitable turbine engine, such as, for example, turbofan engines, propfan engines, turbojet engines, turboprop engines, or turboshaft engines.

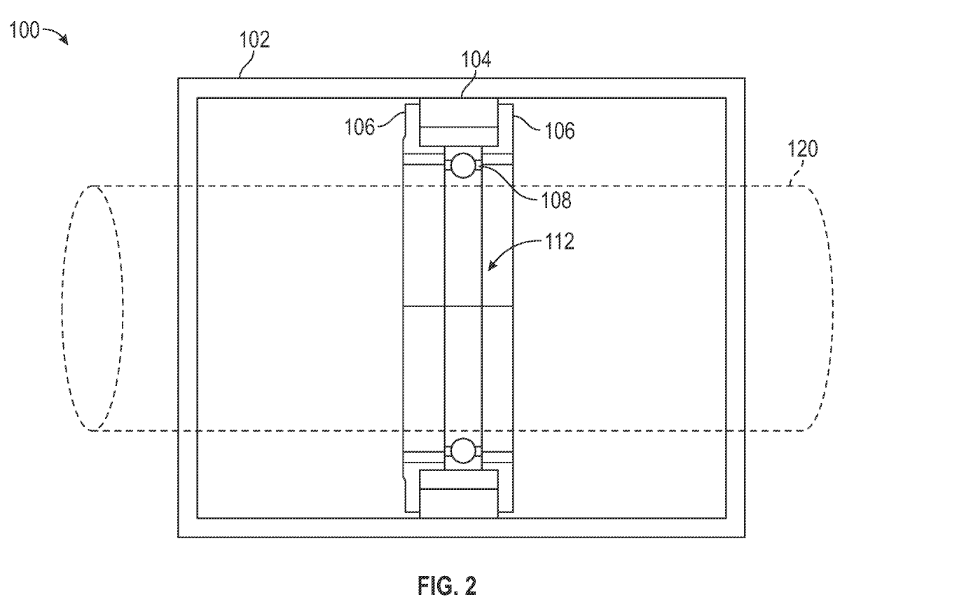

FIG. 2 is a schematic view of an exemplary bearing damper assembly 100 for the turbine engine 10, taken along the longitudinal centerline axis 12 of the turbine engine 10, according to the present disclosure. The bearing damper assembly 100 can be utilized to engage a rotating component 120 of the turbine engine 10. The bearing damper assembly 100, however, can be used to engage any rotating component of the turbine engine 10, or any rotating component of other turbine engines. Particularly, the rotating component 120 may be any rotating component of the turbo-engine 16 (e.g., the LP shaft 36 or the HP shaft 34) of the turbine engine 10 (FIG. 1). By way of example, circles (bearing damper assembly (BDA)) of FIG. 1 provide example locations that the bearing damper assembly 100 of the present disclosure may be incorporated into the turbine engine 10. In some embodiments, the turbine engine 10 may include two or more bearing damper assemblies 100 at two or more suitable locations as indicated by circles BDA.

As shown in FIG. 2, the bearing damper assembly 100 includes a damper frame 102, a bearing housing 104, end seal plates 106, and bearings 108. In the illustrated embodiment, an outer surface (e.g., an outer rim) of the bearing housing 104 is coupled to an inner surface of the damper frame 102. In some embodiments, the outer rim of the bearing housing 104 may be fixedly coupled to the damper frame 102 (e.g., via screws, nuts, or other suitable fastening mechanisms). In such embodiments, movement of the outer rim of the bearing housing 104 relative to the damper frame 102 may be limited.

The bearings 108 are coupled to an inner surface (e.g., an inner rim) of the bearing housing 104 and define an annular region 112, which may support the rotating component 120. As described above, the bearings 108 may facilitate rotation of the rotating component 120, for example, by reducing friction that resists rotation. In the illustrated embodiment, the bearings 108 are ball bearings. In some embodiments, the bearings 108 may be, for example, journal bearings (i.e., porous bearing pads that deliver gas into the annular region 112).

The rotating component 120 may exert a force through the bearings 108 onto the bearing housing 104. For example, gravity may pull downward on the rotating component 120, thereby causing the rotating component 120 to exert a radial force on the bearing housing 104. Additionally, thrust from movement of the turbine engine 10 may cause the rotating component 120 to exert an axial force on the bearing housing 104. Furthermore, during operation of the turbine engine 10, vibrations may be produced on the rotating component 120 (e.g., due to mass imbalance) that may propagate into the bearing housing 104. In some instances, vibrations of the rotating component 120 may affect operation of the turbine engine 10, for example, by disturbing or displacing other components. As such, the bearing housing 104 may be used to damp (e.g., dissipate) vibrations of the rotating component 120, thereby reducing likelihood of vibrations affecting operation of the turbine engine 10.

Various types of dampers may be utilized in the bearing damper assembly 100 to damp vibrations of the rotating component 120. For example, in the illustrated embodiment, the bearing housing 104 of the bearing damper assembly 100 is a squeeze film damper that utilizes fluid in annular gaps formed between the outer rim and the inner rim of the bearing housing 104. In this way, damping characteristics (e.g., targeted frequencies or a targeted damping value) of the bearing housing 104 may be dependent, at least in part, on a pressure of the fluid in the annular gaps. To facilitate control of pressure of the fluid, as depicted, the end seal plates 106 are coupled on both axial side surfaces of the bearing housing 104.

In some embodiments, the fluid pressure in the bearing housing 104 may be actively controlled (e.g., in real-time during operation of the turbine engine 10) by pumping fluid through the annular gaps of the bearing housing 104 that flows out through the end seal plates 106. In other embodiments, the annular gaps of the bearing housing 104 may be hermetically sealed and, thus, fluid pressure may be passively controlled (e.g., off-line before deployment of the bearing housing 104). Additionally, in some embodiments, the bearing housing 104 may include at least three circumferentially bounded annular gaps between the outer rim and the inner rim (i.e., a segmented squeeze film damper), which may facilitate improving damping performance. For example, compared to a “two pi” squeeze film damper (i.e., a bearing housing having only two annular gaps opposed in the radial direction), a segmented squeeze film damper may have a higher damping value, which may reduce the likelihood of conditions that affect the damping characteristics, such as cavitation and air ingestion.

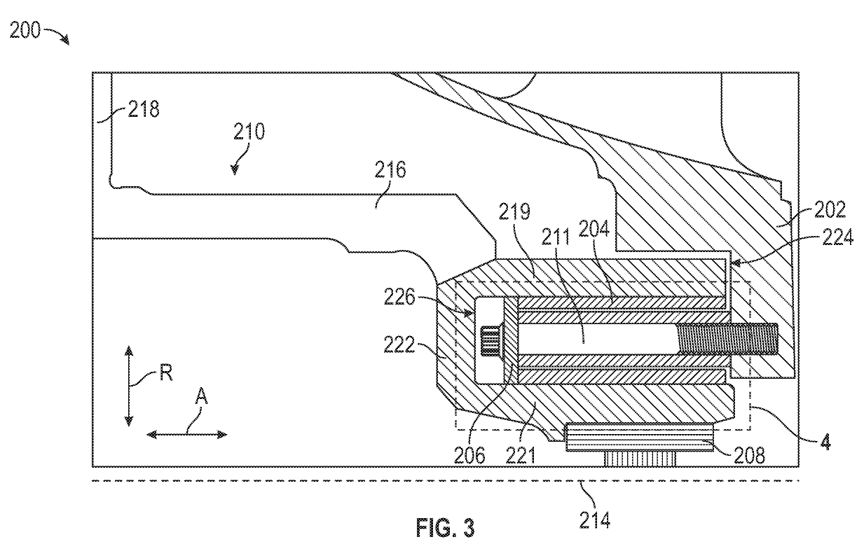

FIG. 3 is a schematic, cross-sectional view that illustrates another exemplary bearing damper assembly 200 of the turbine engine 10 (FIG. 1), according to another embodiment. The bearing damper assembly 200 is substantially similar to the bearing damper assembly 100 of FIG. 2. The same reference numerals or similar reference numerals will be used for components of the bearing damper assembly 200 that are the same as, or similar to, the components of the bearing damper assembly 100 discussed above with regard to FIG. 2. The description of such components above of the bearing damper assembly 100 also applies to these components of the bearing damper assembly 200, and a detailed description of these components is omitted here.

As shown in FIG. 3, the bearing damper assembly 200 includes a damper frame 202, a bearing housing 204 disposed in (e.g., coupled to) the damper frame 202, an end seal plate 206 coupled to the bearing housing 204, bearings 208 (only one shown in FIG. 3), and an external spring 210. In the illustrated embodiment, the damper frame 202, the bearing housing 204, the end seal plate 206, and the external spring 210 are annular such that bearing damper assembly 200 defines a bearing damper centerline axis 214. A radial direction R extends perpendicular to the bearing damper centerline axis 214, and a circumferential direction C extends about the bearing damper centerline axis 214. In some embodiments, one or more of the damper frame 202, the bearing housing 204, the end seal plate 206, or the external spring 210 may not be annular.

The bearing housing 204 is coupled to the damper frame 202 and the end seal plate 206 is coupled to the bearing housing 204. For example, in the illustrated embodiment, a plurality of housing fasteners 211 (only one shown in FIG. 3) couples both the bearing housing 204 to the damper frame 202 and the end seal plate 206 to the bearing housing 204. The damper frame 202 may be coupled to a static component or a static structure (e.g., a frame) of the turbine engine 10. The bearings 208 are supported by the bearing housing 204, radially inward from the damper frame 202, and define an annular region, which may support a rotating component, e.g., the rotating component 120 of FIG. 2.

The external spring 210 includes a plurality of spring fingers 216 (only one shown in FIG. 3) that collectively define at least a portion of the annular region about the bearing damper centerline axis 214. As shown in FIG. 3, the spring finger 216 has a first end 218 and a second end 222 extending from the first end 218. The first end 218 of the spring finger 216 is fixedly coupled to a static component or a static structure of the turbine engine 10, e.g., a frame thereof. In some embodiments, the first ends 218 of the plurality of spring fingers 216 may be fixedly coupled (e.g., secured) to the damper frame 202. The second end 222 of the spring finger 216 is coupled to the bearing housing 204 to limit movement of the bearing housing 204 relative to the external spring 210. Particularly, in the illustrated embodiment, an outer wall 219 of the second end 222 of the spring finger 216 is received within a flange portion 224 of the damper frame 202 and at least a portion of the bearing housing 204 is received within a finger channel 226 defined by the outer wall 219 and an inner wall 221, radially inward of the outer wall 219, of the second end 222 of the spring finger 216. In this way, the second end 222 of the spring finger 216 and at least a portion of the bearing housing 204 are movable, in at least the radial direction R, relative to the stationary damper frame 202. Further, in the illustrated embodiment, the bearings 208 are directly coupled to the inner walls 221 of the second ends 222 of the plurality of spring fingers 216. In some embodiments, the bearings 208 may be directly coupled to the bearing housing 204. For example, in some such embodiments, the second end 222 of the spring finger 216 may be fixedly coupled to a portion of the bearing housing 204 or to the end seal plate 206.

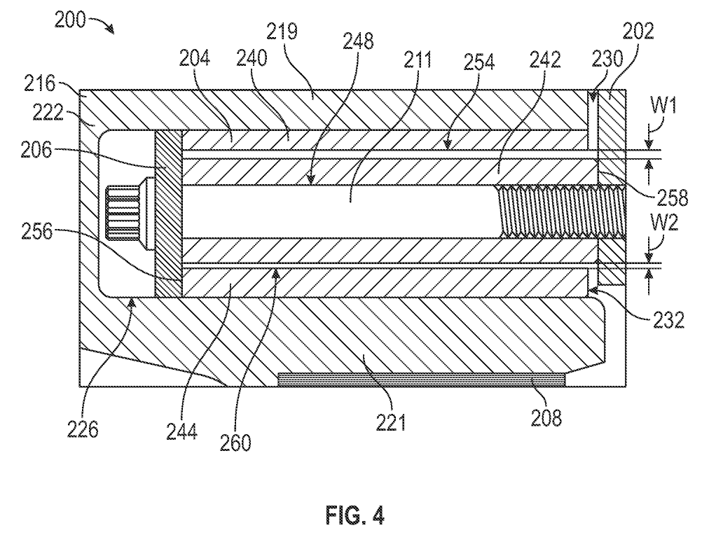

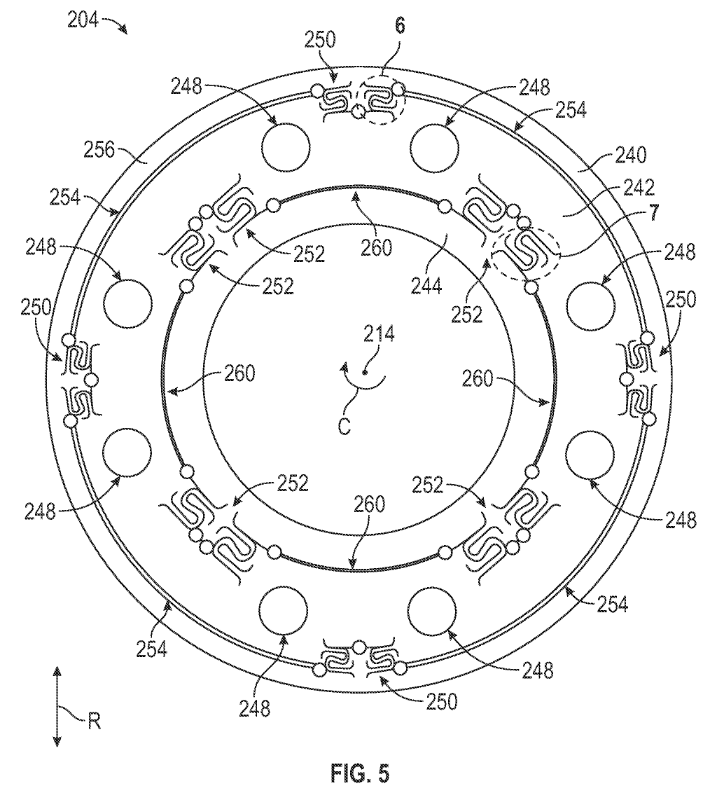

FIG. 4 is an enlarged, cross-sectional, detail view of the area labeled “4” in FIG. 3. FIG. 5 is a front, elevational view of the bearing housing 204 of the bearing damper assembly 200. As shown in FIGS. 4 and 5, the bearing housing 204 has an outer rim 240, a housing base 242 disposed radially inward of the outer rim 240 relative to the radial direction R (FIG. 5), and an inner rim 244 disposed radially inward of the housing base 242 relative to the radial direction R (FIG. 5). In the illustrated embodiment, the outer rim 240, the housing base 242, and the inner rim 244 of the bearing housing 204 are annular about the bearing damper centerline axis 214. In some embodiments, one or more of the outer rim 240, the housing base 242, or the inner rim 244 of the bearing housing 204 may not be annular. For example, in some such embodiments, at least the outer rim 240 of the bearing housing 204 may not be annular.

The housing base 242 of the bearing housing 204 is fixedly coupled to the damper frame 202. Particularly, in the illustrated embodiment, the bearing housing 204 defines a plurality of housing openings 248 (only one shown in FIG. 4) that extends through the housing base 242 and receives the plurality of housing fasteners 211, which fixedly couple the housing base 242 to the damper frame 202. In the illustrated embodiment, the outer rim 240 and the inner rim 244 of the bearing housing 204 are not directly coupled to the damper frame 202.

As shown in FIG. 5, the bearing housing 204 defines a first plurality of annular gaps 254 between the outer rim 240 and the housing base 242, and a second plurality of annular gaps 260 between the inner rim 244 and the housing base 242. In the illustrated embodiment, the first plurality of annular gaps 254 and the second plurality of annular gaps 260 extend into a first axial side 256 and through a second axial side 258 (FIG. 4) of the bearing housing 204. The bearing housing 204 further defines a first plurality of integral springs 250 that couples the outer rim 240 to the housing base 242 and a second plurality of integral springs 252 that couples the inner rim 244 to the housing base 242. In other words, in the illustrated embodiment, the stationary housing base 242 is coupled to both the outer rim 240 and the inner rim 244 via the first plurality of integral springs 250 and the second plurality of integral springs 252, respectively. In this way, the outer rim 240 and the inner rim 244 of the bearing housing 204 (as well as the second end 222 of the spring finger 216 (FIG. 4)) are movable, in at least the radial direction R, relative to the stationary housing base 242 (and to the damper frame 202 (FIG. 4)).

Each annular gap of the first plurality of annular gaps 254 is bound in the circumferential direction C by two integral springs of the first plurality of integral springs 250. In other words, one integral spring of the first plurality of integral springs 250 is disposed on either circumferential end of each annular gap of the first plurality of annular gaps 254. Likewise, each annular gap of the second plurality of annular gaps 260 is bound in the circumferential direction C by two integral springs of the second plurality of integral springs 252. In other words, one integral spring of the second plurality of integral springs 252 is disposed on either circumferential end of each annular gap of the second plurality of annular gaps 260.

In the illustrated embodiment, first plurality of annular gaps 254 includes at least four annular gaps, the first plurality of integral springs 250 includes at least eight integral springs, the second plurality of annular gaps 260 includes at least four annular gaps, and the second plurality of integral springs 252 includes at least eight integral springs. However, the number and the arrangement of the first plurality of integral springs 250, the second plurality of integral springs 252, the first plurality of annular gaps 254, and the second plurality of annular gaps 260 of the bearing housing 204 is not limited to any particular number or arrangement, and the number and the arrangement can be selected based on a desired damping characteristic to be provided to a rotating component (e.g., the rotating component 120 of FIG. 2). For example, in some embodiments, the first plurality of annular gaps 254 may include at least two annular gaps, the first plurality of integral springs 250 may include at least four integral springs, the second plurality of annular gaps 260 may include at least two annular gaps, and the second plurality of integral springs 252 may include at least four integral springs. In some embodiments, the first plurality of annular gaps 254 may include at least five annular gaps, the first plurality of integral springs 250 may include at least ten integral springs, the second plurality of annular gaps 260 may include at least five annular gaps, and the second plurality of integral springs 252 may include at least ten integral springs. In some embodiments, the first plurality of annular gaps 254 may include a total number of annular gaps that differs from that of the second plurality of annular gaps 260. In some embodiments, the first plurality of integral springs 250 may include a total number of integral springs that differs from that of the second plurality of integral springs 252.

As shown in FIG. 4, each of the first plurality of annular gaps 254 has a first gap size W1 as measured in the radial direction R (FIG. 3) between a radially inner surface of the outer rim 240 and a radially outer surface of the housing base 242. Likewise, each of the second plurality of annular gaps 260 has a second gap size W2 as measured in the radial direction R between a radially outer surface of the inner rim 244 and a radially inner surface of the housing base 242. In the illustrated embodiment, the first gap size W1 of the first plurality of annular gaps 254 is greater than the second gap size W2 of the second plurality of annular gaps 260. In this way, the first plurality of annular gaps 254 may provide a damping value that is greater than that provided by the second plurality of annular gaps 260. In some embodiments, the second gap size W2 of the second plurality of annular gaps 260 may be greater than, or substantially equal to, the first gap size W1 of the first plurality of annular gaps 254.

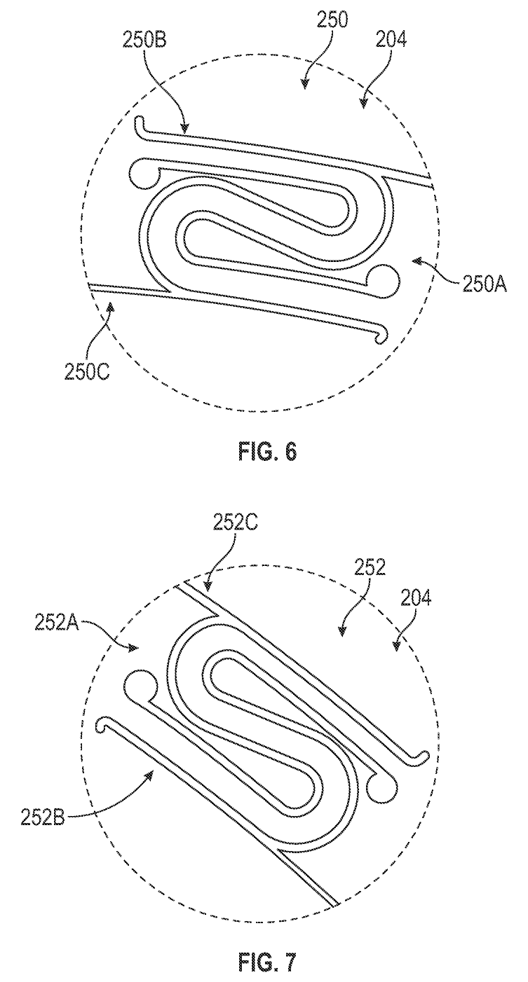

FIG. 6 is an enlarged, detail view of the area labeled “6” in FIG. 5. As shown in FIG. 6, each integral spring of the first plurality of integral springs 250 includes a spring portion 250A, an active damper portion 250B, and a deflection limiter portion 250C. The spring portions 250A of the first plurality of integral springs 250 are compressible in the radial direction R (FIG. 5) such that at least portions of the outer rim 240 (FIG. 5) may move or orbit relative to the stationary housing base 242 (FIG. 5) and to the damper frame 202 (FIGS. 3 and 4). The active damper portions 250B of the first plurality of integral springs 250 are each connected to the respective one of the first plurality of annular gaps 254 (FIG. 5). The deflection limiter portions 250C of the first plurality of integral springs 250 are each connected to that of another directly adjacent integral spring of the first plurality of integral springs 250. In this way, the deflection limiter portions 250C of the first plurality of integral springs 250 may limit deflection of the outer rim 240 relative to the housing base 242 of the bearing housing 204.

Each of the integral springs of the second plurality of integral springs 252 of the bearing housing 204 is configured similar to the first plurality of integral springs 250, but may differ in orientation, size, etc. For example, FIG. 7 is an enlarged, detail view of the area labeled “7” in FIG. 5. As shown in FIG. 7, each integral spring of the second plurality of integral springs 252 includes a spring portion 252A, an active damper portion 252B, and a deflection limiter portion 252C. The spring portions 252A of the second plurality of integral springs 252 are compressible in the radial direction R (FIG. 5) such that at least portions of the inner rim 244 (FIG. 5) may move or orbit relative to the stationary housing base 242 (FIG. 5) and to the damper frame 202 (FIGS. 3 and 4). The active damper portions 252B of the second plurality of integral springs 252 are each connected to the respective one of the second plurality of annular gaps 260 (FIG. 5). The deflection limiter portions 252C of the second plurality of integral springs 252 are each connected to that of another directly adjacent integral spring of the second plurality of integral springs 252. In this way, the deflection limiter portions 252C of the second plurality of integral springs 252 may limit deflection of the inner rim 244 relative to the housing base 242 of the bearing housing 204.

Referring again to FIG. 5, each of the integral springs of the first plurality of integral springs 250 of the bearing housing 204 is arranged such that the active damper portion 250B (FIG. 6) is disposed radially outward of the deflection limiter portion 250C (FIG. 6) relative to the bearing damper centerline axis 214. On the other hand, each of the integral springs of the second plurality of integral springs 252 of the bearing housing 204 is arranged such that the active damper portion 252B (FIG. 7) is disposed radially inward of the deflection limiter portion 252C (FIG. 7) relative to the bearing damper centerline axis 214. Further, in the illustrated embodiment, the first plurality of integral springs 250 and the second plurality of integral springs 252 are arranged such that each of the integral springs of the first plurality of integral springs 250 is disposed circumferentially between two radially adjacent integral springs of the second plurality of integral springs 252 in the circumferential direction C, and each of the integral springs of the second plurality of integral springs 252 is disposed circumferentially between two radially adjacent integral springs of the first plurality of integral springs 250 in the circumferential direction C. In this way, when the inner rim 244 and the outer rim 240 move in a first radial direction relative to the housing base 242 (e.g., as the second end 222 of the spring finger 216 deflects in the first radial direction relative to the housing base 242 and the damper frame 202), some of the first plurality of integral springs 250 in the first radial direction compress while some of the second plurality of integral springs 252 in a second radial direction, opposite the first radial direction, compress and provide a damping counterforce in the second radial direction.

The first plurality of integral springs 250 of the bearing housing 204 may have a first spring coefficient (e.g., stiffness) that provides a first spring stiffness between the outer rim 240 and the housing base 242. Likewise, the second plurality of integral springs 252 of the bearing housing 204 may have a second spring coefficient that provides a second spring stiffness between the inner rim 244 and the housing base 242. In some embodiments, the first spring coefficient of the first plurality of integral springs 250 may be different (e.g., greater or less) than the second spring coefficient of the second plurality of integral springs 252. For example, in some such embodiments, the first spring coefficient of the first plurality of integral springs 250 may be less than the second spring coefficient of the second plurality of integral springs 252. In other embodiments, the first spring coefficient of the first plurality of integral springs 250 may be substantially equal to the second spring coefficient of the second plurality of integral springs 252.

In the illustrated embodiment, the first plurality of integral springs 250 is integrally formed with the outer rim 240 and the housing base 242 and the second plurality of integral springs 252 is integrally formed with the inner rim 244 and the housing base 242 such that the bearing housing 204 is a monolithic, single piece. In some embodiments, the first plurality of integral springs 250 and the second plurality of integral springs 252 may be integrally formed with the bearing housing 204 via a subtractive manufacturing process, such as, e.g., a wire electrical discharge machining process. In some embodiments, the bearing housing 204 may be formed via one or more additive manufacturing processes.

By utilizing the first plurality of annular gaps 254 and the second plurality of annular gaps 260, as maintained respectively by the first plurality of integral springs 250 and the second plurality of integral springs 252, the bearing housing 204 may increase viscous resistance, thereby reducing a likelihood of circumferential flow, which may enable an increased gap size (e.g., the first gap size W1 or the second gap size W2 (FIG. 4)) of one or both of the first plurality of annular gaps 254 or the second plurality of annular gaps 260. In this way, the amount of fluid in each annular gap of the first plurality of annular gaps 254 and the second plurality of annular gaps 260 may be increased, which may facilitate an increased damping value of the bearing damper assembly 200 and may reduce a likelihood of conditions (e.g., cavitation and air ingestion in the first plurality of annular gaps 254 and the second plurality of annular gaps 260) that affect the overall damping characteristics of the bearing damper assembly 200. As described above, the damping characteristics of the bearing damper assembly 200 may also be affected by fluid pressure within the first plurality of annular gaps 254 and the second plurality of annular gaps 260 of the bearing housing 204. In some embodiments, fluid pressure within at least one of the first plurality of annular gaps 254 or the second plurality of annular gaps 260 may be actively controlled by independently controlling flow of fluid into the first plurality of annular gaps 254 and the second plurality of annular gaps 260.

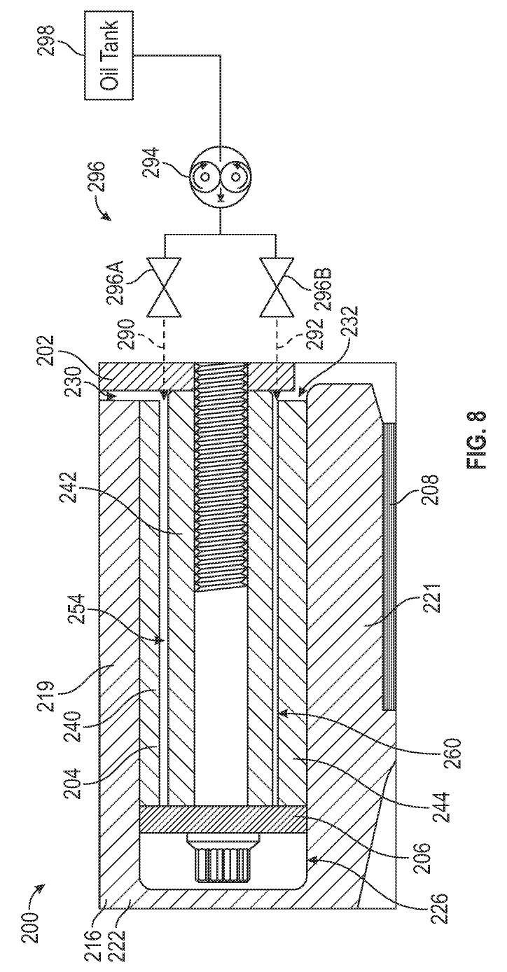

In this regard, FIG. 8 is a schematic view of a first fluid circuit 290 and a second fluid circuit 292 of the bearing damper assembly 200 of FIGS. 3-7. As shown in FIG. 8, fluid provided to the first fluid circuit 290 flows to each annular gap of the first plurality of annular gaps 254 while fluid provided to the second fluid circuit 292 flows to each annular gap of the second plurality of annular gaps 260. In the illustrated embodiment, the first fluid circuit 290 is fluidly isolated from the second fluid circuit 292.

Particularly, the first fluid circuit 290 includes at least one first inlet (not shown) in fluid communication with the first plurality of annular gaps 254 and the second fluid circuit 292 includes at least one second inlet (not shown) in fluid communication with the second plurality of annular gaps 260. In some embodiments, the at least one first inlet of the first fluid circuit 290 or the at least one second inlet of the second fluid circuit 292 may be defined by the damper frame 202 or by the second ends 222 of the plurality of spring fingers 216. In some embodiments, a radially outer surface of the outer rim 240 of the bearing housing 204 may define a first annular groove and a second annular groove extending in the circumferential direction C (FIG. 5). The first annular groove and the second annular groove may be in fluid communication with the first plurality of annular gaps 254 and the second plurality of annular gaps 260, respectively, such that the first annular groove and the second annular groove at least partially define the at least one first inlet of the first fluid circuit 290 and the at least one second inlet of the second fluid circuit 292, respectively. In some embodiments, the end seal plate 206 may define a plurality of plate recesses (not shown) that may define the at least one first inlet of the first fluid circuit 290 and the at least one second inlet of the second fluid circuit 292.

In some embodiments, at least one of the first fluid circuit 290 or the second fluid circuit 292 may be configured such that fluid flows from the at least one first inlet or from the at least one first inlet, respectively, to each of the annular gaps of the first plurality of annular gaps 254 or the second plurality of annular gaps 260, respectively, in parallel (i.e., simultaneously). In some embodiments, at least one of the first fluid circuit 290 or the second fluid circuit 292 may be configured such that fluid flows from the at least one first inlet or from the at least one first inlet, respectively, to each of the annular gaps of the first plurality of annular gaps 254 or the second plurality of annular gaps 260, respectively, in series.

Referring still to FIG. 8, fluid within the first plurality of annular gaps 254 and the second plurality of annular gaps 260 flows out of the first plurality of annular gaps 254 and the second plurality of annular gaps 260, respectively. Particularly, the first fluid circuit 290 includes a first plurality of outlets (not shown) in fluid communication with the first plurality of annular gaps 254 and the second fluid circuit 292 includes a second plurality of outlets (not shown) in fluid communication with the second plurality of annular gaps 260. For example, in the illustrated embodiment of FIGS. 3-8, the second end 222 of the spring finger 216 and the bearing housing 204 are arranged such that an outer gap 230 and an inner gap 232, radially inward of the outer gap 230 relative to the bearing damper centerline axis 214 (FIG. 3), are defined between respective portions of the bearing housing 204 and the damper frame 202. Thus, in some embodiments, the plurality of outer gaps 230 may define the first plurality of outlets of the first fluid circuit 290 and the plurality of inner gaps 232 may define the second plurality of outlets of the second fluid circuit 292. In other embodiments, at least one of the first plurality of outlets of the first fluid circuit 290 or the second plurality of outlets of the second fluid circuit 292 may be defined by the second ends 222 of the plurality of spring fingers 216 of the external spring 210 (FIG. 3). For example, in some such embodiments, the outer walls 219 of the second ends 222 of the plurality of spring fingers 216 may define the first plurality of outlets of the first fluid circuit 290 while the inner walls 221 of the second ends 222 of the plurality of spring fingers 216 may define the second plurality of outlets of the second fluid circuit 292. In some embodiments, the damper frame 202 may define a plurality of frame recesses (not shown) that may define at least one of the first plurality of outlets of the first fluid circuit 290 or the second plurality of outlets of the second fluid circuit 292. In some embodiments, the first fluid circuit 290 can include a single first outlet in fluid communication with the first plurality of annular gaps 254 or the second fluid circuit 292 can include a single second outlet in fluid communication with the second plurality of annular gaps 260.

As shown in FIG. 8, the bearing damper assembly 200 further includes a pump 294 that provides fluid (e.g., from an oil tank 298) to the first fluid circuit 290 (e.g., via the at least one first inlet (not shown) thereof) and to the second fluid circuit 292 (e.g., via the at least one second inlet (not shown) thereof). One or more valves 296 may be disposed between the pump 294 and the at least one first inlet of the first fluid circuit 290 or the at least one second inlet of the second fluid circuit 292 to selectively provide fluid to one or both of the first fluid circuit 290 or the second fluid circuit 292. Thus, fluid pressure within one or both of the first plurality of annular gaps 254 or the second plurality of annular gaps 260 may be varied by controlling flow of fluid to the first plurality of annular gaps 254 and the second plurality of annular gaps 260 of the bearing housing 204 via control of the pump 294 and the one or more valves 296. For example, in the illustrated embodiment, the one or more valves 296 includes a first valve 296A disposed between the pump 294 and the at least one first inlet of the first fluid circuit 290 and a second valve 296B disposed between the pump 294 and the at least one second inlet of the second fluid circuit 292. In this way, the bearing damper assembly 200 can be operated in one of at least three damping modes—a first damping mode, a second damping mode, and a third damping mode—via control of the first valve 296A and the second valve 296B.

Particularly, the bearing damper assembly 200 can be operated in the first damping mode by operating the pump 294 with each of the first valve 296A and the second valve 296B in open positions, such that fluid from the pump 294 is supplied to each of the first plurality of annular gaps 254 and the second plurality of annular gaps 260 of the bearing housing 204. With the bearing damper assembly 200 operating in the first damping mode, both a first plurality of circumferential damping sectors corresponding to the first plurality of annular gaps 254 and a second plurality of circumferential damping sectors corresponding to the second plurality of annular gaps 260 are activated (i.e., providing active damping). In the illustrated embodiment, the second plurality of circumferential damping sectors (i.e., the second plurality of annular gaps 260) is radially inward of the first plurality of circumferential damping sectors (i.e., the first plurality of annular gaps 254) relative to the bearing damper centerline axis 214 (FIG. 5). Thus, while operating in the first damping mode, the bearing damper assembly 200 can provide a first damping level.

Referring still to FIG. 8, the bearing damper assembly 200 can be operated in the second damping mode by operating the pump 294 with the first valve 296A in the open position and the second valve 296B in a closed position, such that fluid from the pump 294 is supplied only to the first plurality of annular gaps 254 of the bearing housing 204. With the bearing damper assembly 200 operating in the second damping mode, the first plurality of circumferential damping sectors is activated, while the second plurality of circumferential damping sectors is deactivated (i.e., not providing active damping). Thus, while operating in the second damping mode, the bearing damper assembly 200 can provide a second damping level that is different (e.g., less) than the first damping level.

The bearing damper assembly 200 can be operated in the third damping mode by operating the pump 294 with the first valve 296A in a closed position and the second valve 296B in the open position, such that fluid from the pump 294 is supplied only to the second plurality of annular gaps 260 of the bearing housing 204. With the bearing damper assembly 200 operating in the third damping mode, the first plurality of circumferential damping sectors is deactivated, while the second plurality of circumferential damping sectors is activated. Thus, while operating in the third damping mode, the bearing damper assembly 200 can provide a third damping level that is different (e.g., less) than the first damping level and that is different (e.g., greater or less) than the second damping level.

In the illustrated embodiment of FIG. 8, the pump 294 is a gear pump and the first valve 296A and the second valve 296B are two-way ball valves. In some embodiments, the pump 294 may be a centrifugal pump, a positive displacement pump, a screw pump, etc., and the first valve 296A and the second valve 296B may be, for example, a solenoid actuated ball valve. In some embodiments, the first valve 296A may be a different type of valve than the second valve 296B. In some embodiments, the bearing damper assembly 200 can include two or more pumps 294. For example, in some such embodiments, the bearing damper assembly 200 can include a first pump in fluid communication with the first fluid circuit 290 and a second pump in fluid communication with the second fluid circuit 292. In some such embodiments, the bearing damper assembly 200 may not include the one or more valves 296. In some embodiments, the one or more valves 296 of the bearing damper assembly 200 can include at least three valves. For example, in some such embodiments, the one or more valves 296 of the bearing damper assembly 200 can include a first plurality of valves that control flow of fluid to respective annular gaps of the first plurality of annular gaps 254 and a second plurality of valves that control flow of fluid to respective annular gaps of the second plurality of annular gaps 260.

In some embodiments, the bearing damper assembly 200 can further include an electronic controller (not shown) in electrical communication with the first valve 296A and the second valve 296B. In some such embodiments, the electronic controller can be configured to selectively operate the bearing damper assembly 200 (e.g., via control of the first valve 296A and the second valve 296B) in the first damping mode, the second damping mode, or the third damping mode. For example, in some such embodiments, the electronic controller can be configured, in response to a first operating condition (e.g., a first sensed speed of the rotating component 120 (FIG. 2)) of the turbine engine 10 (FIG. 1), to operate the bearing damper assembly 200 in the first damping mode, and, in response to a second operating condition (e.g., a second sensed speed of the rotating component 120 that is less than first speed) of the turbine engine 10, operate the bearing damper assembly 200 in the second damping mode. Further, the electronic controller can be further configured, in response to a third operating condition (e.g., a third sensed speed of the rotating component 120 that is less than the second speed) of the turbine engine 10 (FIG. 1), to operate the bearing damper assembly 200 in the third damping mode.

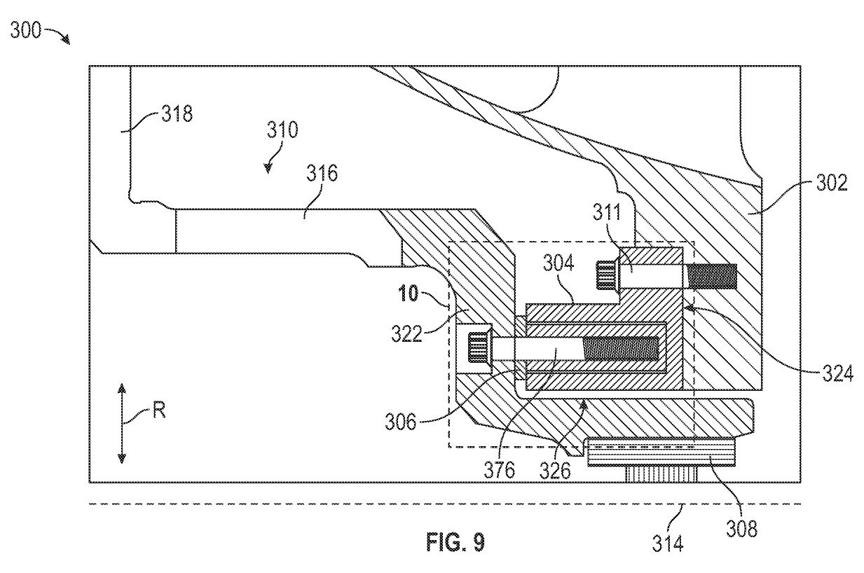

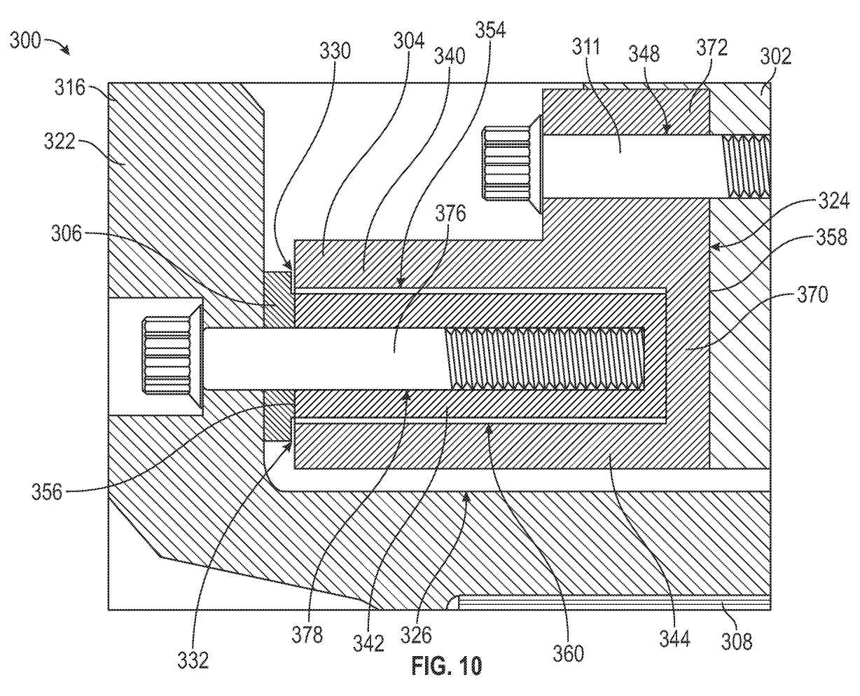

FIGS. 9 and 10 illustrate another exemplary bearing damper assembly 300, e.g., the bearing damper assembly 100 of FIG. 2 or the bearing damper assembly 200 of FIGS. 3-8, of the turbine engine 10 (FIG. 1), according to another embodiment. FIG. 9 is a schematic, cross-sectional view of the bearing damper assembly 300, and FIG. 10 is an enlarged, cross-sectional, detail view of the area labeled “10” in FIG. 9. The bearing damper assembly 300 is substantially similar to the bearing damper assembly 100 of FIG. 2 and to the bearing damper assembly 200 of FIGS. 3-8. The same reference numerals or similar reference numerals will be used for components of the bearing damper assembly 300 that are the same as, or similar to, the components of the bearing damper assemblies 100 and 200 discussed above with regard to FIGS. 2-8. The description of such components above of the bearing damper assemblies 100 and 200 also applies to these components of the bearing damper assembly 300, and a detailed description of these components is omitted here.

As shown in FIG. 9, the bearing damper assembly 300 includes a damper frame 302, a bearing housing 304, an end seal plate 306, bearings 308, and an external spring 310 including a plurality of spring fingers 316 (only one shown in FIG. 9), similar to the damper frame 202, the bearing housing 204, the end seal plate 206, the bearings 208, and the external spring 210 of the bearing damper assembly 200 of FIGS. 3-8. Further, the bearing housing 304 of the bearing damper assembly 300 includes an outer rim 340, a housing base 342, and an inner rim 344 (FIG. 10), similar to outer rim 240, the housing base 242, and the inner rim 244 of the bearing housing 204 of FIGS. 3-8. In the illustrated embodiment, the damper frame 302, the bearing housing 304, the end seal plate 306, and the external spring 310 are annular such that bearing damper assembly 300 defines a bearing damper centerline axis 314, and the outer rim 340, the housing base 342, and the inner rim 344 of the bearing housing 304 are annular about the bearing damper centerline axis 314. The bearing housing 304 further includes a first plurality of annular gaps 354 (FIG. 10), a second plurality of annular gaps 360 (FIG. 10), a first plurality of integral springs (not shown), and a second plurality of integral springs (not shown), similar to the first plurality of annular gaps 254, the second plurality of annular gaps 260, the first plurality of integral springs 250, and the second plurality of integral springs 252 of the bearing housing 204 of FIGS. 3-8.

In the illustrated embodiment of FIGS. 9 and 10, the outer rim 340 and the inner rim 344 of the bearing housing 304 are fixedly coupled to the damper frame 302 while the housing base 342 of the bearing housing 304 is coupled to a second end 322 of the spring finger 316, opposite a first end 318 (FIG. 9). In this way, the housing base 342 of the bearing housing 304 (as well as the second end 322 of the spring finger 316) is movable, in at least the radial direction R (FIG. 9), relative to the outer rim 340 and the inner rim 344 of the bearing housing 304 (and to the damper frame 302).

Particularly, the outer rim 340 and the inner rim 344 of the bearing housing 304 are connected to each other via a connecting wall 370 extending between the outer rim 340 and the inner rim 344 at a second axial side 358 of the bearing housing 304, opposite a first axial side 356. An outer flange 372 of the bearing housing 304 extends radially outward from the connecting wall 370 adjacent to the outer rim 340 such that the connecting wall 370 and the outer flange 372 define the second axial side 358 of the bearing housing 304. The connecting wall 370 and the outer flange 372 of the bearing housing 304 are received within a flange portion 324 of the damper frame 302. In the illustrated embodiment, the outer flange 372 is fixedly coupled to the damper frame 302 via a plurality of housing fasteners 311 that are received within a first plurality of housing openings 348 (only one shown in FIG. 10) defined by the outer flange 372.

At least a portion of the bearing housing 304 is received within a finger channel 326 defined by the second end 322 of the spring finger 316. The end seal plate 306 is disposed between the first axial side 356 of the bearing housing 304 and the second end 322 of the spring finger 316. The end seal plate 306 may define an outer gap 330 and an inner gap 332, radially inward of the outer gap 330 relative to the bearing damper centerline axis 314 (FIG. 3), that are in fluid communication with the respective annular gaps of the first plurality of annular gaps 354 and the second plurality of annular gaps 360. The housing base 342 of the bearing housing 304 is coupled to the second end 322 of the spring finger 316 via a plurality of finger fasteners 376 that are received within a second plurality of housing openings 378 (only one shown in FIG. 10) defined by the housing base 342.

In some embodiments, the bearing housing 304 may not include the connecting wall 370 such that the outer rim 340 and the inner rim 344 are not directly connected. For example, in some such embodiments, the outer flange 372 can extend radially outward from the outer rim 340 and the bearing housing 304 may further include an inner flange (not shown) that can extend radially inward from the inner rim 344. In some such embodiments, both the outer flange 372 and the inner flange (not shown) of the bearing housing 304 may be fixedly coupled to the damper frame 302.

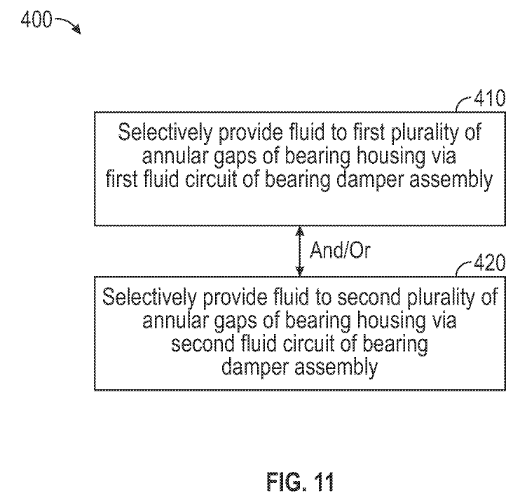

FIG. 11 is a flowchart showing a method 400 of damping vibrations of a rotating component of a turbine engine via a bearing damper assembly. While reference is made to the bearing damper assembly 200 of FIGS. 3-8, the method 400 can be utilized with any one of the bearing damper assemblies 100, 200, and 300 of FIGS. 2-10 or with any other bearing damper systems of other turbine engines.

In step 410, the method 400 includes selectively providing fluid to a first plurality of annular gaps of a bearing housing via a first fluid circuit of a bearing damper assembly. For example, with reference to the bearing damper assembly 200 illustrated in FIGS. 3-8, step 410 includes providing fluid, via the pump 294 (FIG. 8), to the first plurality of annular gaps 254 of the bearing housing 204 of the bearing damper assembly 200 via the first fluid circuit 290. In some embodiments, step 410 can include operating the bearing damper assembly 200 in the second damping mode, e.g., by moving the first valve 296A to the open position and the second valve 296B to the closed position. In some embodiments, the controller (not shown) of the bearing damper assembly 200 may selectively provide fluid to the first fluid circuit 290 by controlling the first valve 296A and the second valve 296B to cause the bearing damper assembly 200 to operate in the second damping mode.

In step 420, the method 400 includes selectively providing fluid to a second plurality of annular gaps of the bearing housing via a second fluid circuit of the bearing damper assembly. For example, with reference to the bearing damper assembly 200 illustrated in FIGS. 3-8, step 420 includes providing fluid, via the pump 294 (FIG. 8), to the second plurality of annular gaps 260 of the bearing housing 204 of the bearing damper assembly 200 via the second fluid circuit 292. In some embodiments, step 420 can include operating the bearing damper assembly 200 in the third damping mode, e.g., by moving the first valve 296A to the closed position and the second valve 296B to the open position. In some embodiments, the controller (not shown) of the bearing damper assembly 200 may selectively provide fluid to the second fluid circuit 292 by controlling the first valve 296A and the second valve 296B to cause the bearing damper assembly 200 to operate in the third damping mode.

In some embodiments, step 420 may be performed before step 410, as indicated by the double-headed arrow in FIG. 11. In some embodiments, step 410 and step 420 may be performed simultaneously. For example, with reference to the bearing damper assembly 200 illustrated in FIG. 8, in some such embodiments, step 410 and step 420 can include operating the bearing damper assembly 200 in the first damping mode, e.g., by moving the first valve 296A and the second valve 296B to the open positions. In some such embodiments, the controller (not shown) of the bearing damper assembly 200 may selectively provide fluid simultaneously to the first fluid circuit 290 and to the second fluid circuit 292 by controlling the first valve 296A and the second valve 296B to cause the bearing damper assembly 200 to operate in the first damping mode. In some embodiments, method 400 may include only one of step 410 or step 420, or both step 410 and step 420, as indicated by “and/or” in FIG. 11. Also, step 410 may be performed first, or step 420 may be performed first.

Accordingly, the present disclosure provides for an improved bearing damper assembly for a turbine engine that can be operated in a plurality of variable damping modes for various operating modes of the turbine engine. Particularly, embodiments of the present disclosure can provide a bearing damper assembly with a first plurality of annular gaps and a second plurality of annular gaps, radially inward of the first plurality of annular gaps, that can be activated independent of one another to provide various damping characteristics of the bearing damper assembly, which can increase operational performance and durability of the bearing damper assembly and the turbine engine over a range of operating modes.

Further aspects of the present disclosure are provided by the subject matter of the following clauses.

A bearing damper assembly for a turbine engine defines a bearing damper centerline axis, a radial direction extending perpendicular to the bearing damper centerline axis, and a circumferential direction about the bearing damper centerline axis. The bearing damper assembly includes a damper frame, a bearing housing disposed in the damper frame, and an end seal plate coupled to the bearing housing. The bearing housing is annular and includes a housing base, an outer rim disposed radially outward of the housing base relative to the radial direction and coupled to the housing base via a first plurality of integral springs such that a first plurality of annular gaps is formed between the outer rim and the housing base, and an inner rim disposed radially inward of the housing base relative to the radial direction and coupled to the housing base via a second plurality of integral springs such that a second plurality of annular gaps is formed between the inner rim and the housing base. Each annular gap of the first plurality of annular gaps is bound in the circumferential direction by two integral springs of the first plurality of integral springs, the first plurality of integral springs being in fluid communication with a first fluid circuit of the bearing damper assembly. Each annular gap of the second plurality of annular gaps being bound in the circumferential direction by two integral springs of the second plurality of integral springs, the second plurality of integral springs being in fluid communication with a second fluid circuit of the bearing damper assembly. The first plurality of annular gaps and the second plurality of annular gaps are configured to be filled with fluid via the first fluid circuit and the second fluid circuit, respectively, to damp vibrations produced on a rotating component of the turbine engine.

The bearing damper assembly of the preceding clause, further including an external spring comprising a plurality of spring fingers, each spring finger of the plurality of spring fingers having a first end fixedly coupled to a frame of the turbine engine and a second end that engages the bearing housing.

The bearing damper assembly of any preceding clause, the housing base of the bearing housing is fixedly coupled to the damper frame such that the outer rim and the inner rim are movable relative to the housing base, the damper frame, or both.

The bearing damper assembly of any preceding clause, the end seal plate is coupled to the housing base of the bearing housing.

The bearing damper assembly of any preceding clause, the outer rim and the inner rim of the bearing housing is fixedly coupled to the damper frame such that the housing base is movable relative to the outer rim, the inner rim, the damper frame, or all three.

The bearing damper assembly of any preceding clause, further including an external spring including a plurality of spring fingers, each spring finger of the plurality of spring fingers having a first end fixedly coupled to a frame of the turbine engine and a second end that engages the bearing housing. The housing base of the bearing housing is coupled to the second ends of the plurality of spring fingers.

The bearing damper assembly of any preceding clause, the first plurality of annular gaps has a first gap size, as measured in the radial direction, and the second plurality of annular gaps has a second gap size, as measured in the radial direction, that is different from the first gap size.

The bearing damper assembly of any preceding clause, the first gap size is greater than the second gap size.

The bearing damper assembly of any preceding clause, the first plurality of integral springs has a first spring coefficient and the second plurality of integral springs has a second spring coefficient that is different from the first spring coefficient.

The bearing damper assembly of any preceding clause, the first spring coefficient is less than the second spring coefficient.

The bearing damper assembly of any preceding clause, the first plurality of annular gaps includes at least two annular gaps, and the second plurality of annular gaps includes at least two annular gaps.

The bearing damper assembly of any preceding clause, the first plurality of annular gaps includes at least four annular gaps, and the second plurality of annular gaps includes at least four annular gaps.

The bearing damper assembly of any preceding clause, a number of annular gaps of the first plurality of annular gaps is equal to a number of annular gaps of the second plurality of annular gaps.

The bearing damper assembly of any preceding clause, further including a pump in fluid communication with the first fluid circuit and the second fluid circuit to provide fluid to the first plurality of annular gaps and the second plurality of annular gaps, respectively.

The bearing damper assembly of any preceding clause, further including at least one valve disposed between the pump and the first fluid circuit and the second fluid circuit, the at least one valve being controllable to control a flow of fluid provided to the first fluid circuit and to the second fluid circuit.

The bearing damper assembly of any preceding clause, further including an electronic controller in electrical communication with the at least one valve, the electronic controller being configured to selectively provide fluid to the first fluid circuit and to the second fluid circuit via control of the at least one valve.

The bearing damper assembly of any preceding clause, the at least one valve including a first valve disposed between the pump and the first fluid circuit and a second valve disposed between the pump and the second fluid circuit.

The bearing damper assembly of any preceding clause, each integral spring of the first plurality of integral springs including a spring portion and an active damper portion, the spring portion being compressible in the radial direction such that at least portions of the outer rim may move or orbit relative to the stationary housing base and to the damper frame, and the active damper portion being connected to the respective one of the first plurality of annular gaps.

The bearing damper assembly of any preceding clause, each integral spring of the first plurality of integral springs further including a deflection limiter portion connected to that of another directly adjacent integral spring of the first plurality of integral springs to limit deflection of the outer rim relative to the housing base of the bearing housing.

The bearing damper assembly of any preceding clause, each integral spring of the second plurality of integral springs including a spring portion and an active damper portion, the spring portion being compressible in the radial direction such that at least portions of the inner rim may move or orbit relative to the stationary housing base and to the damper frame, and the active damper portion being connected to the respective one of the second plurality of annular gaps.

The bearing damper assembly of any preceding clause, each integral spring of the second plurality of integral springs further including a deflection limiter portion connected to that of another directly adjacent integral spring of the second plurality of integral springs to limit deflection of the inner rim relative to the housing base of the bearing housing.

A method of damping vibrations of a rotating component of a turbine engine includes selectively providing fluid to at least one of a first fluid circuit of a bearing damper assembly that is in fluid communication with a first plurality of annular gaps formed between a housing base and an outer rim of a bearing housing of the bearing damper assembly, or a second fluid circuit of the bearing damper assembly that is in fluid communication with a second plurality of annular gaps formed between the housing base and an inner rim of the bearing housing of the bearing damper assembly. The second plurality of annular gaps is disposed radially inward of the first plurality of annular gaps. Each annular gap of the first plurality of annular gaps is circumferentially bound by two integral springs of a first plurality of integral springs of the bearing housing. Each annular gap of the second plurality of annular gaps is circumferentially bound by two integral springs of a second plurality of integral springs of the bearing housing.

The method of the preceding clause, the housing base of the bearing housing is fixedly coupled to a damper frame of the bearing damper assembly such that the outer rim and the inner rim of the bearing housing are movable relative to the housing base and to the damper frame.

The method of any preceding clause, the outer rim and the inner rim of the bearing housing are fixedly coupled to a damper frame of the bearing damper assembly such that the housing base of the bearing housing is movable relative to the outer rim, the inner rim, the damper frame, or all three.

Although the foregoing description is directed to the preferred embodiments, it is noted that other variations and modifications will be apparent to those skilled in the art and may be made without departing from the disclosure. Moreover, features described in connection with one embodiment may be used in conjunction with other embodiments, even if not explicitly stated above.

1. A bearing damper assembly for a turbine engine, the bearing damper assembly defining a bearing damper centerline axis, a radial direction extending perpendicular to the bearing damper centerline axis, and a circumferential direction about the bearing damper centerline axis, the bearing damper assembly comprising:
a damper frame;
a bearing housing disposed in the damper frame, the bearing housing being annular and comprising:
a housing base;
an outer rim disposed radially outward of the housing base relative to the radial direction, the outer rim being coupled to the housing base via a first plurality of integral springs such that a first plurality of annular gaps is formed between the outer rim and the housing base, each annular gap of the first plurality of annular gaps being bound in the circumferential direction by two integral springs of the first plurality of integral springs, the first plurality of integral springs in fluid communication with a first fluid circuit of the bearing damper assembly; and
an inner rim disposed radially inward of the housing base relative to the radial direction, the inner rim being coupled to the housing base via a second plurality of integral springs such that a second plurality of annular gaps is formed between the inner rim and the housing base, each annular gap of the second plurality of annular gaps being bound in the circumferential direction by two integral springs of the second plurality of integral springs, the second plurality of integral springs being in fluid communication with a second fluid circuit of the bearing damper assembly; and
an end seal plate coupled to the bearing housing,
wherein the first plurality of annular gaps and the second plurality of annular gaps are configured to be filled with fluid via the first fluid circuit and the second fluid circuit, respectively, to damp vibrations produced on a rotating component of the turbine engine.

2. The bearing damper assembly of claim 1, further comprising an external spring comprising a plurality of spring fingers, each spring finger of the plurality of spring fingers having a first end fixedly coupled to a frame of the turbine engine and a second end that engages the bearing housing.

3. The bearing damper assembly of claim 1, wherein the housing base of the bearing housing is fixedly coupled to the damper frame such that the outer rim and the inner rim are movable relative to the housing base, the damper frame, or both.

4. The bearing damper assembly of claim 3, wherein the end seal plate is coupled to the housing base of the bearing housing.

5. The bearing damper assembly of claim 1, wherein the outer rim and the inner rim of the bearing housing are fixedly coupled to the damper frame such that the housing base is movable relative to the outer rim, the inner rim, the damper frame, or all three.

6. The bearing damper assembly of claim 5, further comprising an external spring comprising a plurality of spring fingers, each spring finger of the plurality of spring fingers having a first end fixedly coupled to a frame of the turbine engine and a second end that engages the bearing housing, the housing base of the bearing housing being coupled to the second ends of the plurality of spring fingers.

7. The bearing damper assembly of claim 1, wherein the first plurality of annular gaps has a first gap size, as measured in the radial direction, and the second plurality of annular gaps has a second gap size, as measured in the radial direction, that is different from the first gap size.

8. The bearing damper assembly of claim 7, wherein the first gap size is greater than the second gap size.

9. The bearing damper assembly of claim 1, wherein the first plurality of integral springs has a first spring coefficient and the second plurality of integral springs has a second spring coefficient that is different from the first spring coefficient.

10. The bearing damper assembly of claim 9, wherein the first spring coefficient is less than the second spring coefficient.

11. The bearing damper assembly of claim 1, wherein the first plurality of annular gaps includes at least two annular gaps, and the second plurality of annular gaps includes at least two annular gaps.

12. The bearing damper assembly of claim 11, wherein the first plurality of annular gaps includes at least four annular gaps, and the second plurality of annular gaps includes at least four annular gaps.

13. The bearing damper assembly of claim 11, wherein a number of annular gaps of the first plurality of annular gaps is equal to a number of annular gaps of the second plurality of annular gaps.

14. The bearing damper assembly of claim 1, further comprising a pump in fluid communication with the first fluid circuit and the second fluid circuit to provide fluid to the first plurality of annular gaps and the second plurality of annular gaps, respectively.

15. The bearing damper assembly of claim 14, further comprising at least one valve disposed between the pump and the first fluid circuit and the second fluid circuit, the at least one valve being controllable to control a flow of fluid provided to the first fluid circuit and to the second fluid circuit.

16. The bearing damper assembly of claim 15, further comprising an electronic controller in electrical communication with the at least one valve, the electronic controller being configured to selectively provide fluid to the first fluid circuit and to the second fluid circuit via control of the at least one valve.

17. The bearing damper assembly of claim 15, wherein the at least one valve comprises a first valve disposed between the pump and the first fluid circuit and a second valve disposed between the pump and the second fluid circuit.

18. A method of damping vibrations of a rotating component of a turbine engine, the method comprising:
selectively providing fluid to at least one of:
a first fluid circuit of a bearing damper assembly that is in fluid communication with a first plurality of annular gaps formed between a housing base and an outer rim of a bearing housing of the bearing damper assembly; or
a second fluid circuit of the bearing damper assembly that is in fluid communication with a second plurality of annular gaps formed between the housing base and an inner rim of the bearing housing of the bearing damper assembly, the second plurality of annular gaps being disposed radially inward of the first plurality of annular gaps,
wherein each annular gap of the first plurality of annular gaps is circumferentially bound by two integral springs of a first plurality of integral springs of the bearing housing, and each annular gap of the second plurality of annular gaps is circumferentially bound by two integral springs of a second plurality of integral springs of the bearing housing.

19. The method of claim 18, wherein the housing base of the bearing housing is fixedly coupled to a damper frame of the bearing damper assembly such that the outer rim and the inner rim of the bearing housing are movable relative to the housing base and the damper frame.

20. The method of claim 18, wherein the outer rim and the inner rim of the bearing housing are fixedly coupled to a damper frame of the bearing damper assembly such that the housing base of the bearing housing is movable relative to the outer rim, the inner rim, the damper frame, or all three.
